(19) United States
(12) Patent Application Publication
(10) Pub. No.: US 2012/0268937 A1
(43) Pub. Date: Oct. 25, 2012

(54) HEAT DISSIPATION UNIT FOR LED BULB

(76) Inventor: Wen-Jen Lee, New Taipei City (TW)

(21) Appl. No.: 13/090,515

(22) Filed: Apr. 20, 2011

(51) Int. Cl. F21V 29/00; F21S 4/00

(52) U.S. Cl. 362/249.02; 362/373

(57) ABSTRACT

A heat dissipation unit for LED bulb includes a base seat formed with a receiving cavity and a base section, a first heat dissipation member having multiple heat dissipation sections and a perforation, a second heat dissipation member and a retainer member. The heat dissipation sections of the first heat dissipation section are arranged around the perforation. Each heat dissipation section has a first side attached to the base section and a second side. A first through hole is formed in the receiving cavity in communication with the receiving cavity and the perforation. The second heat dissipation member is formed with a second through hole and a spreading section attached to the second side of the heat dissipation section. The retainer member is fitted in the first and second through holes and the perforation to integrally connect the base seat with the first and second heat dissipation members.

### FIELD OF THE INVENTION

The present invention relates generally to a heat dissipation unit for LED bulb, and more particularly to a heat dissipation unit, which can provide excellent heat dissipation effect for an LED bulb to enhance luminous efficiency of the LED bulb.

### BACKGROUND OF THE INVENTION

Recently, the problem of global warming has become more and more serious. Therefore, various green products meeting the requirements of energy saving and carbon reduction have been more and more respected. As for light bulbs, when a conventional incandescent bulb emits light, 90% of the energy is converted into thermal energy, while only 10% of the energy becomes light. Therefore, the luminous efficiency of the conventional incandescent bulb is very low and a great amount of energy is wasted.

Lately, for eliminating the above shortcoming of the conventional incandescent bulbs, various light-emitting devices such as light-emitting diode (LED) bulbs have been developed to substitute for the conventional incandescent bulbs. The LED bulb has the advantages of high brightness, power saving, environmental production, longer lifetime, etc. Moreover, in manufacturing process of the LED bulb, carbon dioxide emission is reduced to lower manufacturing cost as well as minimize the pollution.

Please refer to FIGS. 1A and 1B, which show a conventional LED bulb. The LED bulb includes a shade 10, an LED module 11, a base seat 12, a control circuit 13, a bed member 14 and a shell 15. The base seat 12 is formed with a cavity 121 for receiving the LED module 11 therein. The shade 10 is disposed on and assembled with the base seat 12 to cover the LED module 11. The shell 15 has a receiving space 151 in which the bed member 14 and the base seat 12 are sequentially positioned. The outer circumferences of the base seat 12 and the bed member 14 are attached to the inner circumference of the shell 15. The receiving space 151 has a first opening 153 and a second opening 154 opposite to the first opening 153.

The bed member 14 has a receiving space 141 for receiving the control circuit 13. The bed member 14 further has an electrical connector 143 protruding from the bed member 14 in a direction away from the receiving space 141. The electrical connector 143 extends out of the shell 15 through the second opening 154 thereof to fix the bed member 14 in the receiving space 151. The electrical connector 143 can be screwed and locked with a corresponding bulb holder of a light (not shown).

When the LED module 11 emits light, the LED chips 111 of the LED module 11 will generate very high heat that accumulates in the cavity 121 and the shade 10. In case the heat is not efficiently dissipated, the luminous efficiency of the LED module 11 will be apparently lowered. This may lead to damage to the LED chips 111 or shortening of the lifetime of the LED chips 111 or even burnout of the LED module 11 and the circuit board therein. According to the above, the conventional LED bulb has the following shortcomings:

1. poor heat dissipation efficiency.
2. shortened lifetime of the LED module.
3. lower luminous efficiency of the LED module.

### SUMMARY OF THE INVENTION

A primary object of the present invention is to provide a heat dissipation unit for LED bulb, which can provide excellent heat dissipation effect for an LED bulb.

A further object of the present invention is to provide the above heat dissipation unit for LED bulb, which can enhance luminous efficiency of an LED bulb and prolong lifetime of the LED bulb.

A still further object of the present invention is to provide the above heat dissipation unit for LED bulb, which has larger heat dissipation area.

To achieve the above and other objects, the heat dissipation unit for LED bulb of the present invention includes: a base seat, a first heat dissipation member, a second heat dissipation member and a retainer member. The base seat is formed with a receiving cavity and a base section. A first through hole is formed in the receiving cavity in communization with the receiving cavity. The first heat dissipation member has multiple heat dissipation sections and a perforation in communication with the first through hole. The heat dissipation sections are arranged around the perforation. Each heat dissipation section has a first side and a second side opposite to the first side. The first side is attached to the base section of the base seat.

The second heat dissipation member is formed with a second through hole in communication with the perforation and a spreading section extending from the second through hole. The second side of the heat dissipation section is attached to the spreading section. The retainer member is fitted in the first and second through holes and the perforation to integrally connect the base seat with the first and second heat dissipation members. The heat dissipation unit is applicable to an LED bulb to provide excellent heat dissipation effect and thus enhance the luminous efficiency of the LED bulb.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A is a perspective exploded view of a conventional LED bulb;

FIG. 1B is a sectional assembled view of the conventional LED bulb;

FIG. 2A is a perspective assembled view of a first embodiment of the heat dissipation unit of the present invention;

FIG. 2B is a sectional assembled view of the first embodiment of the heat dissipation unit of the present invention;

FIG. 3 is a perspective exploded view of the first embodiment of the heat dissipation unit of the present invention;

FIG. 4A is a perspective assembled view of the first embodiment of the heat dissipation unit of the present invention, showing that the heat dissipation unit is assembled with an LED bulb;

FIG. 4B is a sectional assembled view of the first embodiment of the heat dissipation unit of the present invention, showing that the heat dissipation unit is assembled with the LED bulb;

FIG. 4C is a sectional assembled view of a second embodiment of the heat dissipation unit of the present invention, showing that the heat dissipation unit is assembled with the LED bulb;

FIG. 4D is a sectional assembled view of a third embodiment of the heat dissipation unit of the present invention, showing that the heat dissipation unit is assembled with the LED bulb;

FIG. 5 is a perspective exploded view of the first embodiment of the heat dissipation unit of the present invention, showing that the heat dissipation unit is applied to the LED bulb;

FIG. 6A is a perspective exploded view of the second embodiment of the heat dissipation unit of the present invention;

FIG. 6B is a perspective exploded view of the third embodiment of the heat dissipation unit of the present invention; and

FIG. 7 is a sectional assembled view of a fourth embodiment of the heat dissipation unit of the present invention, showing that the heat dissipation unit is assembled with the LED bulb.

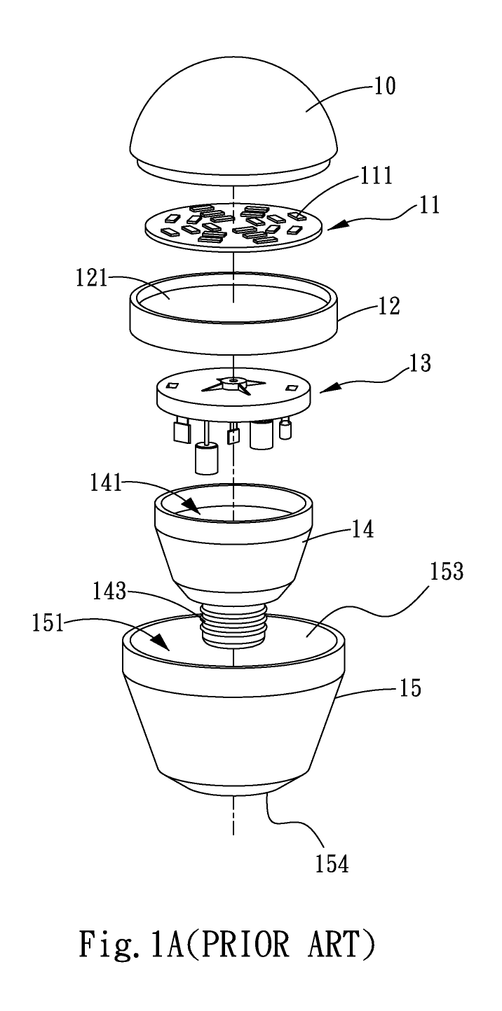

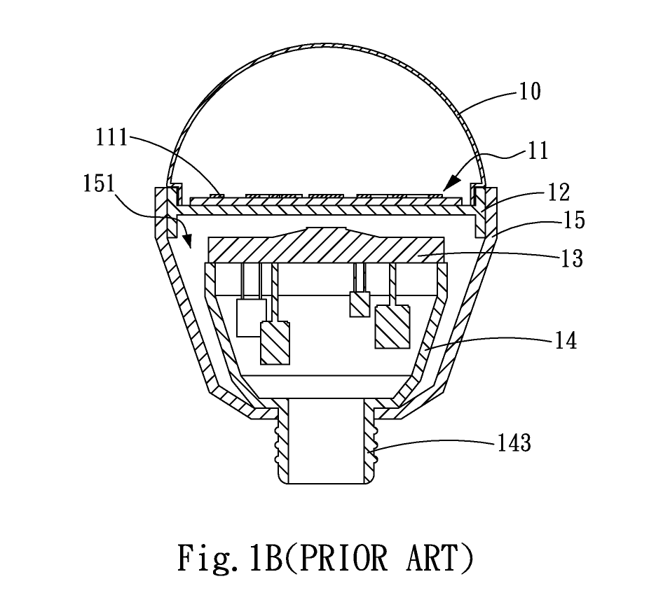

### DETAILED DESCRIPTION OF THE PREFERRED EMBODIMENTS

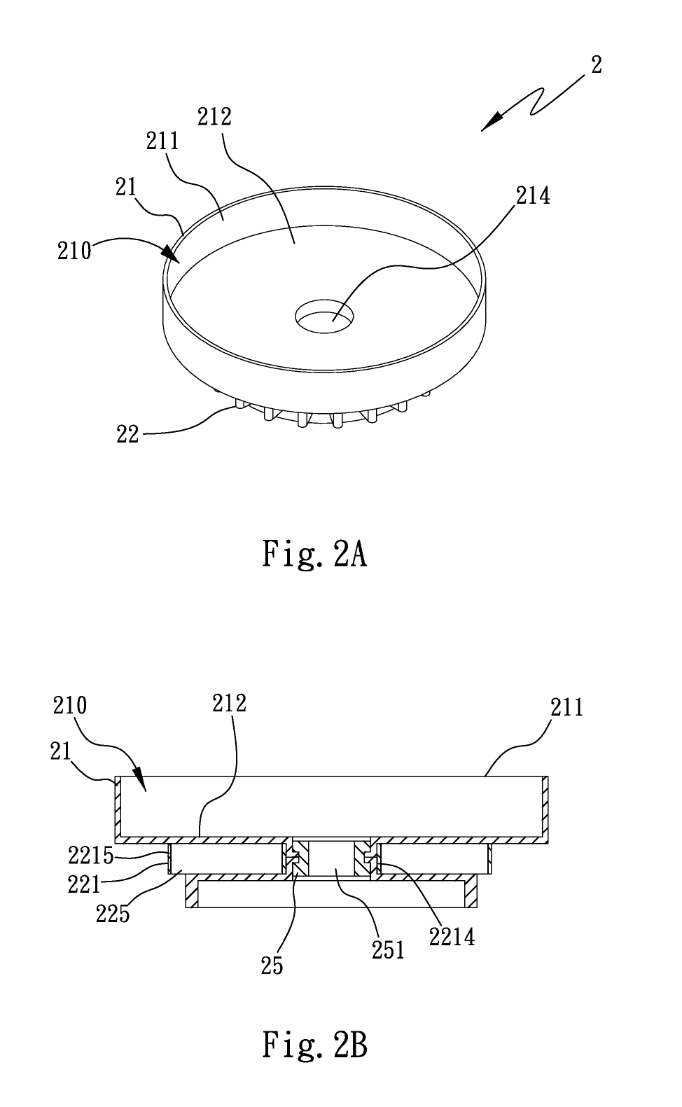

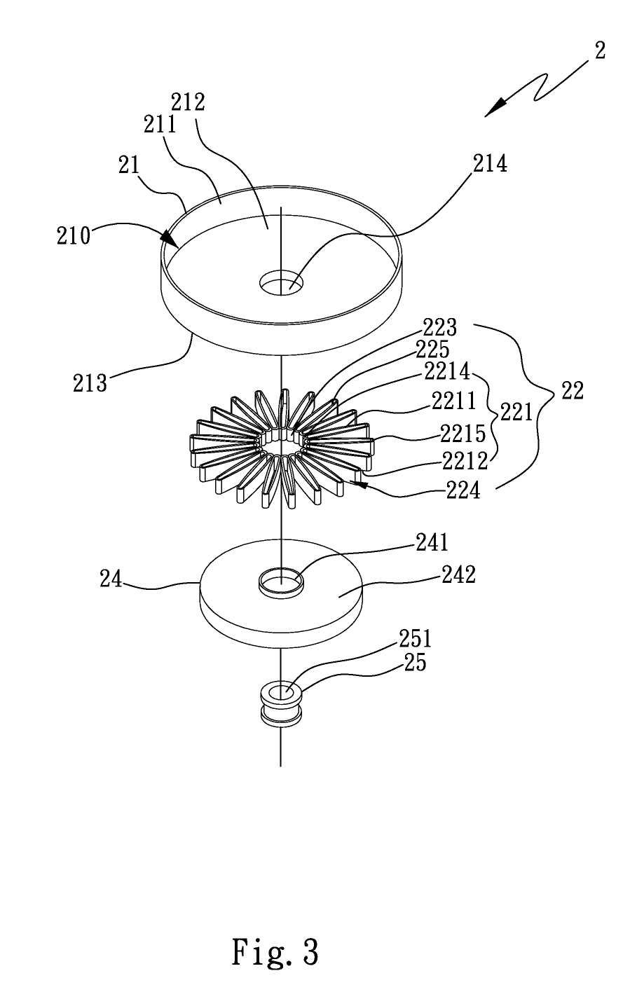

Please refer to FIGS. 2A, 2B and 3. According to a first embodiment, the heat dissipation unit 2 for light-emitting diode (LED) bulb of the present invention includes a base seat 21, a first heat dissipation member 22, a second heat dissipation member 24 and a retainer member 25. The base seat 21 is formed with a receiving cavity 210 and a base section 213. The receiving cavity 210 has an open end 211, a closed end 212 opposite to the open end 211 and a first through hole 214. The open end 211 and the closed end 212 together define the receiving cavity 210. The first through hole 214 is formed at a center of the closed end 212 in communication with the receiving cavity 210. The base seat 21 and the first and second heat dissipation members 22, 24 are made of metal material (such as aluminum, copper and an alloy).

The first heat dissipation member 22 has multiple heat dissipation sections 221 and a perforation 223 in alignment with and in communication with the first through hole 214. The heat dissipation sections 221 are arranged around the perforation 223. Each heat dissipation section 221 has a first side 2211, a second side 2212 opposite to the first side 2211, a connection end 2214 and a heat dissipation end 2215. The first side 2211 is attached to the base section 213 of the base seat 21. The second side 2212 is attached to the second heat dissipation section 24. The heat dissipation sections 221 serve to directly absorb the heat of the base seat 21 and conduct the heat to the heat dissipation ends 2215 and the second heat dissipation member 24. With the heat dissipation sections 221, the heat dissipation area is enlarged to achieve excellent heat dissipation effect.

In this embodiment, the first heat dissipation member 22 has a substantially radial form. However, the configuration of the first heat dissipation member 22 is not limited to the radial form. Alternatively, the first heat dissipation member 22 can have the form of a star or a cross or any other suitable shape.

Please further refer to FIG. 3. The connection ends 2214 of the heat dissipation sections 221 are connected with each other in immediate adjacency to each other to together define the perforation 223. The heat dissipation ends 2215 outward extend from the connection ends 2214. Each two adjacent heat dissipation ends 2215 define therebetween a space 224. In addition, each heat dissipation section 221 has a slot 225 formed through the heat dissipation section 221 between the connection end 2214 and the heat dissipation end 2215.

Referring to FIG. 3 as well as FIG. 2, the second heat dissipation member 24 is formed with a second through hole 241 and a spreading section 242. The second through hole 241 is formed through the second heat dissipation member 24 in alignment with and in communication with the perforation 223. The retainer member 25 has a passageway 251 in communication with the receiving cavity 210. The retainer member 25 is sequentially fitted in the first through hole 214, the perforation 223 and the second through hole 241 to integrally connect the base seat 21 with the first and second heat dissipation members 22, 24.

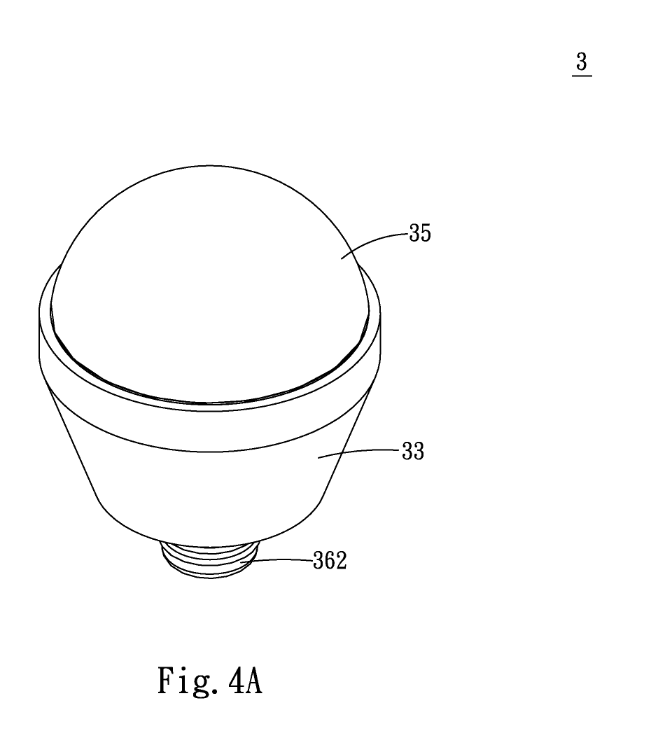

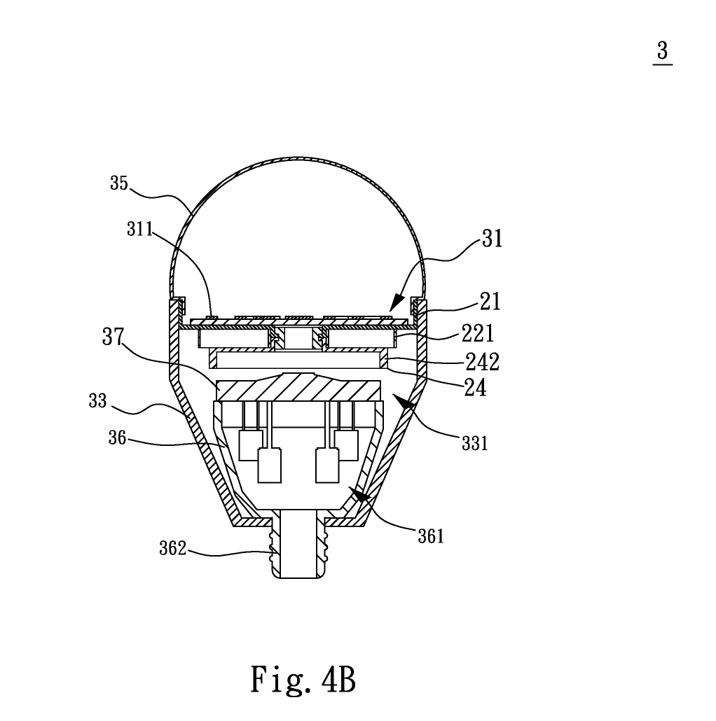

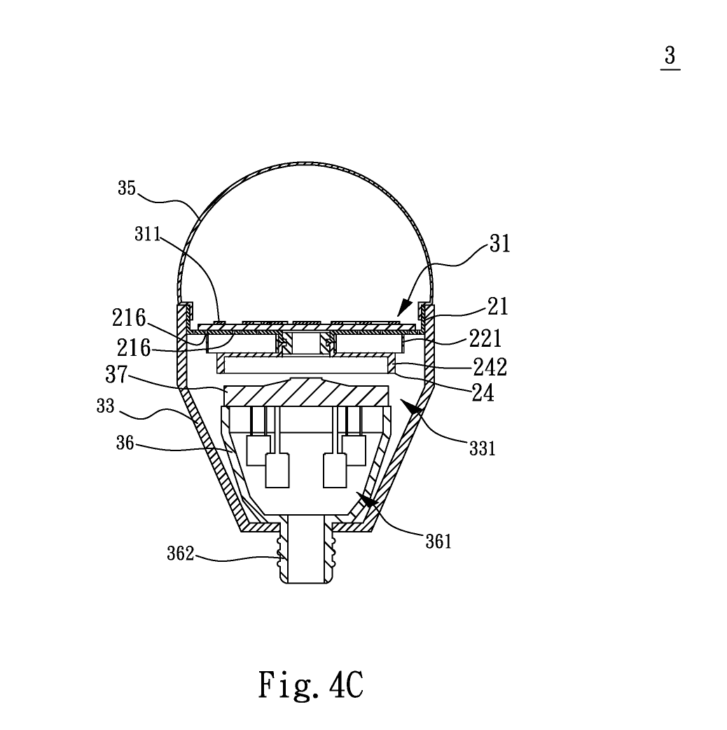

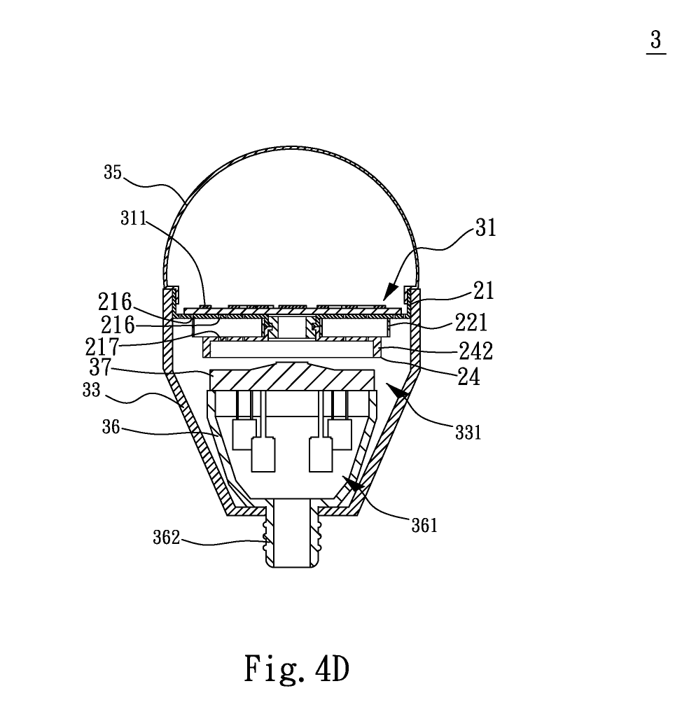

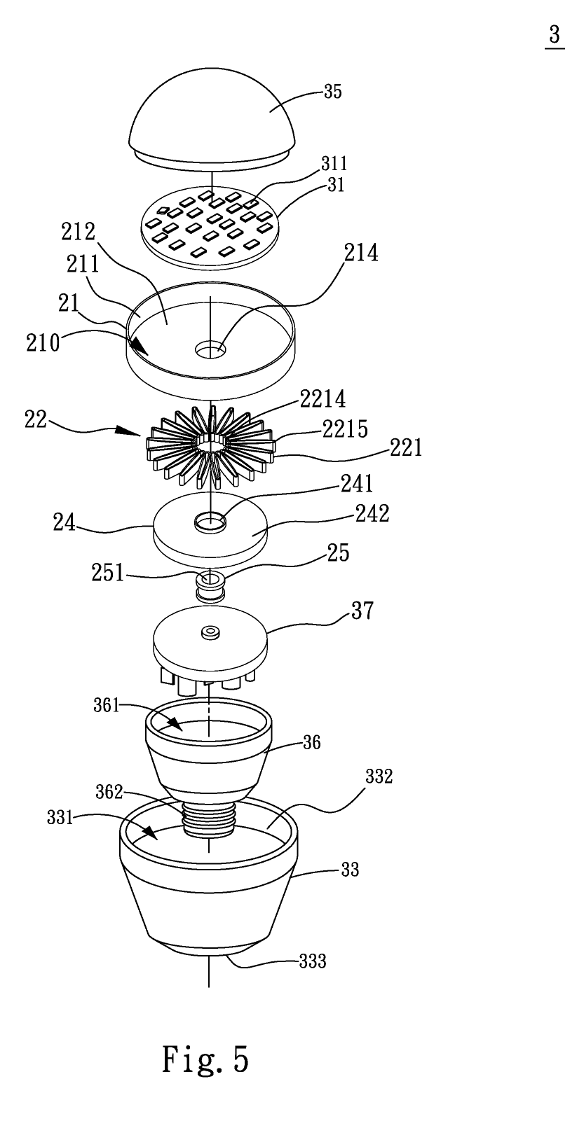

Please refer to FIGS. 4A, 4B and 5. The heat dissipation unit of the present invention is applicable to an LED bulb 3. The LED bulb 3 includes an LED module 31, a shell 33, a transparent shade 35 and a bed member 36. The LED module 31 is disposed on the closed end 212, including multiple LEDs 311. The LEDs 311 are arranged on an end face of the LED module 31 at intervals. The shell 33 has a hollow receiving space 331 in communication with the passageway 251. The base seat 21 and the first and second heat dissipation members 22, 24 (the heat dissipation unit 2) are received in the receiving space 331. The receiving space 331 has a first side 332 and a second open side 333 opposite to the first open side 332. An outer circumference of the base seat 21 is attached to an inner circumference of the first open side 332.

The transparent shade 35 is disposed on the shell 33. To speak more specifically, when assembled, the transparent shade 35 is moved toward the first open side 332 until the transparent shade 35 is fixedly fitted on the shell 33 to cover the LED module 31. The bed member 36 is positioned between the second heat dissipation member 24 and the second open side 333. The bed member 36 has a receiving space 361 and an electrical connector 362. A control circuit 37 is received in the receiving space 361. The electrical connector 362 protrudes from the bed member 36 in a direction away from the receiving space 361. The electrical connector 362 extends out of the shell 33 through the second open side 333 thereof for locking with a corresponding bulb holder of a light (not shown).

When the LED module 31 emits light, the LEDs 311 of the LED module 31 will generate heat. At this time, the base seat 21 quickly absorbs the heat and conducts the heat to the heat dissipation sections 221. The heat dissipation sections 211 then absorb the heat and conduct the heat to the heat dissipation ends 2215 and the spreading section 242 of the second heat dissipation member 24. The heat dissipation ends 2215 and the spreading section 242 then dissipate the heat to the shell 33 by way of radiation. After the shell 33 receives the heat, heat exchange takes place between the shell 33 and the ambient air to dissipate the heat. This can achieve an excellent heat dissipation effect to enhance the luminous efficiency of the LED bulb 3 and prolong the lifetime thereof.

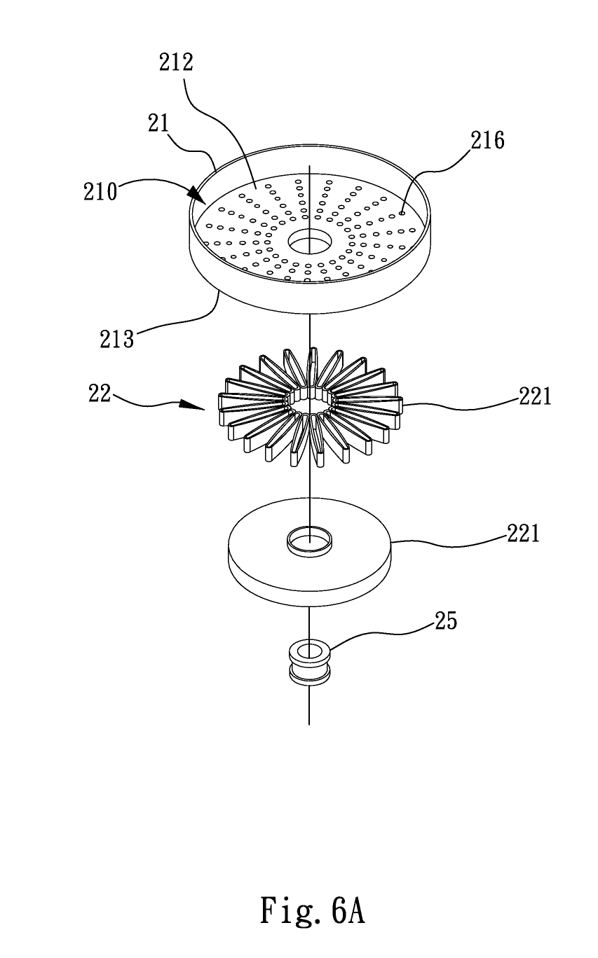

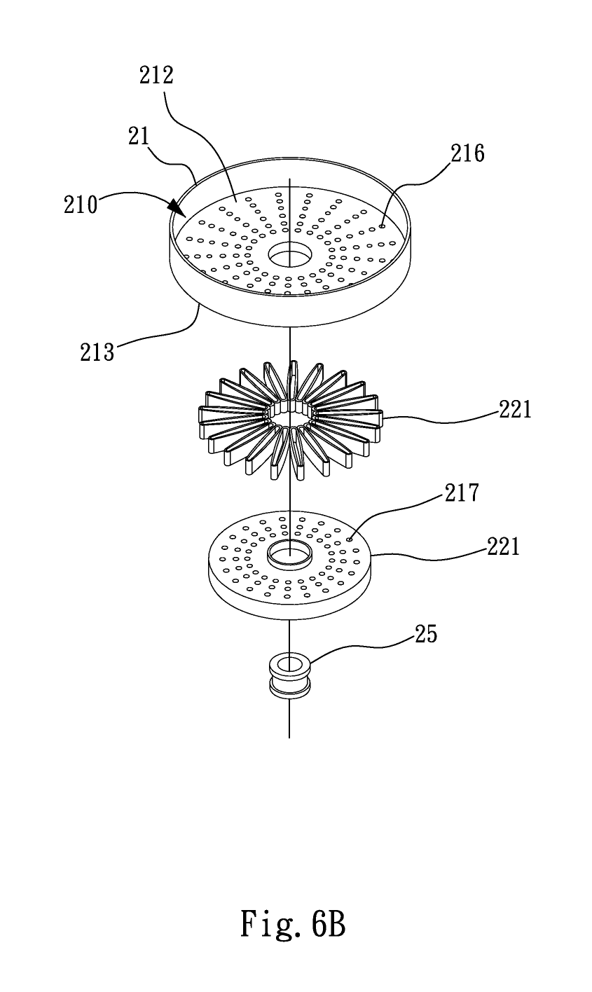

Please now refer to FIGS. 4C and 6A, which show a second embodiment of the present invention. In the second embodiment, the base seat 21 is further formed with multiple first vents 216 passing through the closed end 212 of the receiving cavity 210 and the base section 213. The first vents 216 are respectively positioned on two sides of the corresponding LEDs 311. That is, as shown in FIG. 4C, two first vents 216 are formed on two sides of a section of the closed end 212, which section is right under each LED 311. The first vents 216 help to quickly transfer the heat of the LEDs 311 to the first heat dissipation member 22 for dissipating the heat.

Please now refer to FIGS. 4D and 6B, which show a third embodiment of the present invention. In the third embodiment, the base seat 21 is further formed with multiple first vents 216. The first vents 216 of the third embodiment are identical to those of the second embodiment in structure and function and thus will not be repeatedly described hereinafter. In the third embodiment, the second heat dissipation member 24 is further formed with multiple second vents 217 passing through the spreading section 242 corresponding to the first vents 216.

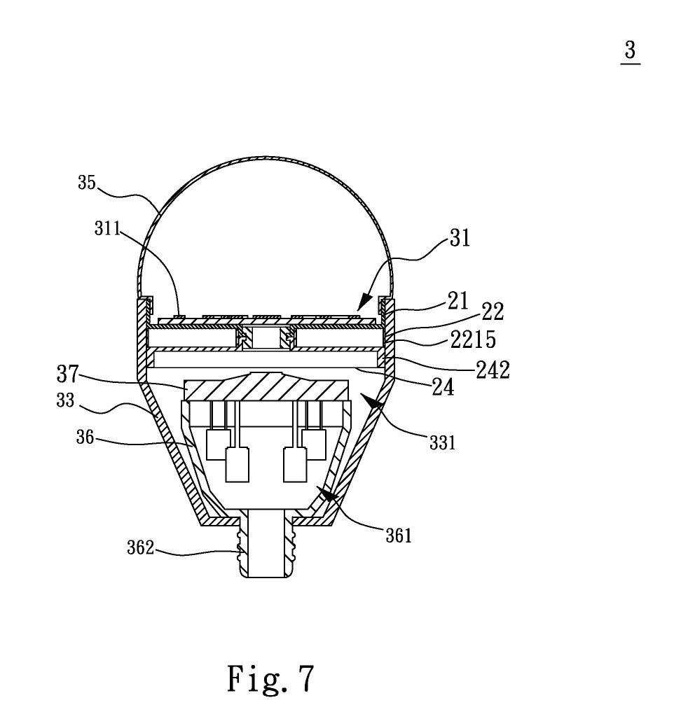

FIG. 7 shows a fourth embodiment of the present invention, which is substantially identical to the first embodiment in structure, connection relationship and function. The fourth embodiment is different from the first embodiment in that the heat dissipation ends 2215 of the first heat dissipation member 22 and the spreading section 242 of the second heat dissipation member 24 extend to abut against the inner circumference of the shell 33. That is, the heat dissipation ends 2215 and the spreading section 242 are attached to the inner circumference of the shell 33 in direct contact therewith. Accordingly, the heat dissipation ends 2215 and the spreading section 242 not only can dissipate the heat to the shell 33 by way of radiation, but also can quickly transfer the heat to the shell 33 by way of conduction. After the shell 33 receives the heat, heat exchange takes place between the shell 33 and the ambient air to dissipate the heat. This can achieve an excellent heat dissipation effect to enhance the luminous efficiency of the LED module 31.

According to the above, in comparison with the conventional device, the present invention has the following advantages:
1. The present invention can achieve an excellent heat dissipation effect.
2. The present invention has larger heat dissipation area.
3. The present invention is able to enhance the luminous efficiency of the LED module and prolong the lifetime thereof.

The above embodiments are only used to illustrate the present invention, not intended to limit the scope thereof. It is understood that many changes and modifications of the above embodiments can be made without departing from the spirit of the present invention. The scope of the present invention is limited only by the appended claims.

What is claimed is:

1. A heat dissipation unit for LED bulb, comprising:
a base seat formed with a receiving cavity and a base section, a first through hole being formed in the receiving cavity in communication with the receiving cavity;
a first heat dissipation member having multiple heat dissipation sections and a perforation in communication with the first through hole, the heat dissipation sections being arranged around the perforation, each heat dissipation section having a first side and a second side opposite to the first side, the first side being attached to the base section of the base seat;
a second heat dissipation member formed with a second through hole in communication with the perforation and a spreading section extending from the second through hole, the second side of the heat dissipation section being attached to the spreading section; and
a retainer member fitted in the first and second through holes and the perforation to integrally connect the base seat with the first and second heat dissipation members.

2. The heat dissipation unit for LED bulb as claimed in claim 1, wherein each heat dissipation section further has a connection end and a heat dissipation end outward extending from the connection end, the connection ends being connected with each other in immediate adjacency to each other, each two adjacent heat dissipation ends defining therebetween a space.

3. The heat dissipation unit for LED bulb as claimed in claim 2, wherein each heat dissipation section has a slot formed through the heat dissipation section between the connection end and the heat dissipation end.

4. The heat dissipation unit for LED bulb as claimed in claim 2, wherein the receiving cavity has an open end and a closed end opposite to the open end.

5. The heat dissipation unit for LED bulb as claimed in claim 2, wherein the first heat dissipation member has a form selected from a group consisting of radial form, star form, cross form and any other suitable form.

6. The heat dissipation unit for LED bulb as claimed in claim 1, wherein the base seat and the first and second heat dissipation members are made of metal material.

7. The heat dissipation unit for LED bulb as claimed in claim 4, which is applied to an LED bulb, the LED bulb including:
an LED module disposed on the closed end and including multiple LEDs;
a shell having a hollow receiving space, the base seat and the first and second heat dissipation members being received in the receiving space, the receiving space having a first side and a second open side opposite to the first open side, an outer circumference of the base seat being attached to an inner circumference of the first open side;
a transparent shade disposed on the shell for covering the LED module; and
a bed member positioned between the second heat dissipation member and the second open side, the bed member having a receiving space and an electrical connector, a control circuit being received in the receiving space, the electrical connector protruding from the bed member in a direction away from the receiving space, the electrical connector also extending out of the shell through the second open side thereof for locking with a corresponding bulb holder.

8. The heat dissipation unit for LED bulb as claimed in claim 7, wherein the retainer member has a passageway in communication with the receiving space and the receiving cavity.

9. The heat dissipation unit for LED bulb as claimed in claim 7, wherein the heat dissipation ends of the first heat dissipation member and the spreading section of the second heat dissipation member extend to abut against the inner circumference of the shell.

10. The heat dissipation unit for LED bulb as claimed in claim 7, wherein the base seat is further formed with multiple first vents passing through the closed end of the receiving cavity and the base section, the first vents being respectively positioned on two sides of the corresponding LEDs.

11. The heat dissipation unit for LED bulb as claimed in claim 10, wherein the second heat dissipation member is further formed with multiple second vents passing through the spreading section corresponding to the first vents.
